(19) United States
(12) Patent Application Publication
(10) Pub. No.: US 2013/0265880 A1
(43) Pub. Date: Oct. 10, 2013

(54) METHOD AND DEVICE FOR GMPLS BASED MULTILAYER LINK MANAGEMENT IN A MULTILAYER NETWORK

(71) Applicant: Won Kyoung Lee, Daejeon (KR)

(72) Inventor: Won Kyoung Lee, Daejeon (KR)

(21) Appl. No.: 13/993,251

(22) PCT Filed: Dec. 5, 2011
(86) PCT No.: PCT/KR11/09347

§ 371 Date: Jun. 11, 2013

(30) Foreign Application Priority Data
Dec. 14, 2010 (KR) 10-2010-0127474

(51) Int. Cl. H04L 12/26

(52) U.S. Cl. CPC H04L 43/08
USPC 370/235; 370/242

(57) ABSTRACT

Provided are a method and apparatus for managing a multilevel link that may calculate a shortest path using a Generalized Multiprotocol Label Switching (GMPLS) control plane only, and may manage a single integrated traffic engineering (TE) link using the GMPLS control plane to control switches for various layers, in a cross layer network environment.

### TECHNICAL FIELD

The present invention relates to a link management technology among Generalized Multiprotocol Label Switching (GMPLS) technologies.

### BACKGROUND ART

A data plane includes various switching layers, for example, an optical transport layer, a time-division multiplexing (TDM) layer, an Ethernet packet layer, an Internet Protocol (IP) packet layer, and the like. Integration of the various switching layers is performed in the data plane. Accordingly, in a multilayer environment, a technology for simultaneously controlling various switching layers with a single generalized multiprotocol label switching (GMPLS) control plane has a great significance in an aspect of efficiency. In particular, a complexity may be reduced in operation, and effective usage of a network source and a fast service provisioning may be expected.

However, most control planes have controlled multiple switching layers independently. In a recent developed technology, an end-to-end path is calculated by collecting traffic engineering link information from each layer in an external virtual topology management system. Without inclusion of a virtual topology management system in a cross layer network environment, it has been impossible to calculate a shorted path and control a switch using a single GMPLS control plane only.

### DISCLOSURE OF INVENTION

### Technical Goals

An aspect of the present invention provides a method and apparatus for managing a multilevel link that may manage the multilevel link using a generalized multiprotocol label switching (GMPLS) control plane only, and may establish an integrated traffic engineering (TE) link, so as to calculate a shortest path and establish a network topology in a cross layer network.

Another aspect of the present invention provides a method and apparatus for managing a multilevel link that may improve a function of detecting a fault of the multilevel link, so as to expedite protection and fault detection of the multilevel link.

### Technical Solutions

According to an aspect of the present invention, there is provided an apparatus for managing a multilevel link, the apparatus including an optical transport layer (OTL) link stack to associate a traffic engineering (TE) link with data links in an OTL, a packet transport layer (PTL) link stack to associate a TE link with data links in a PTL, and a TE link stack to define a correlation between the layers using a first TE link identification (ID) associated with the TE link of the OTL, and a second TE link ID associated with the TE link of the PTL, and to manage multilevel links for both the OTL and the PTL using the defined correlation.

The TE link stack may transmit, to a second node adjacent to a first node, a LinkSummary message comprising a first object having a property of a TE link, and a second object having a property of the data link, and may match a link property of the second node to a link property of the first node by receiving a LinkSummaryAck message from the second node.

The apparatus may further include a control channel to exchange link management protocol (LMP) information with the second node, to search for the second node through a Config message, and to verify a connectivity to the second node by periodically exchanging a Hello message with the second node.

The TE link stack may include a finite state machine (FSM) to exchange link state information of multiple layers with the second node through the LinkSummary message, and to reflect the link state information of the multiple layers in a network topology.

The LinkSummary message may incorporate a flag in the first object having a property of a TE link.

According to another aspect of the present invention, there is provided an apparatus for detecting faults of multilevel links, the apparatus including a converter to monitor a link state at a connection point between an OTL and a PTL, and a data link management block to detect a fault of the connection point using the link state, and to report, to a second node adjacent to a first node, a change in a link state at the detected connection point.

When a fault occurs at the connection point, the data link management block may convert the link state of a lower layer allocated at the connection point between the layers to ‘fail’, and may report, to the second node, a link fault of the lower layer using a ChannelStatus message.

According to an aspect of the present invention, there is provided a method of managing a multilevel link, the method including associating a TE link with data links of an OTL, associating a TE link with data links of a PTL, defining a correlation between the layers using a first TE link ID associated with the TE link of the OTL, and a second TE link ID associated with the TE link of the PTL, and managing multilevel links of both the OTL and the PTL using the defined correlation.

According to another aspect of the present invention, there is provided a method of detecting faults of multilevel links, the method including monitoring a link state at a connection point between an OTL and a PTL, detecting a fault of the connection point using the link state, and reporting, to a second node adjacent to a first node, a change in the link state at the detected connection point.

### Advantageous Effects

According to an embodiment of the present invention, it is possible to manage a multilevel link using a generalized multiprotocol label switching (GMPLS) control plane and may establish an integrated traffic engineering (TE) link, so as to calculate a shortest path and establish a network topology in a cross layer network.

According to another embodiment of the present invention, it is possible to improve a function of detecting a fault of a multilevel link, so as to expedite protection and fault detection of the multilevel link.

### BRIEF DESCRIPTION OF DRAWINGS

FIG. 1 is a block diagram illustrating a correlation of a generalized multiprotocol label switching (GMPLS) protocol according to an embodiment of the present invention.

FIG. 2 is a block diagram illustrating a configuration of an apparatus for managing a multilevel link according to an embodiment of the present invention.

FIG. 3 is a diagram illustrating a configuration of a block to establish an integrated traffic engineering (TE) link according to an embodiment of the present invention.

FIG. 4 is a diagram illustrating a finite state machine that defines a state of a TE link stack according to an embodiment of the present invention.

FIG. 5 is a diagram illustrating a sequence of exchanging a LinkSummary message for a property correlation of an integrated TE link according to an embodiment of the present invention.

FIG. 6 is a diagram illustrating a header format of a LinkSummary message according to an embodiment of the present invention.

FIG. 7 is a diagram illustrating a format of a TE link object in a LinkSummary message according to an embodiment of the present invention.

FIG. 8 is a diagram illustrating formats of TE link objects for multi-layers in a LinkSummary message according to an embodiment of the present invention.

FIG. 9 is a flowchart illustrating a method of managing a multilevel link according to an embodiment of the present invention.

FIG. 10 is a block diagram illustrating a configuration of an apparatus for detecting faults of multilevel links according to another embodiment of the present invention.

FIG. 11 is a diagram illustrating a format of a ChannelStatus message according to an embodiment of the present invention.

FIG. 12 is a flowchart illustrating a method of detecting faults of multilevel links according to another embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

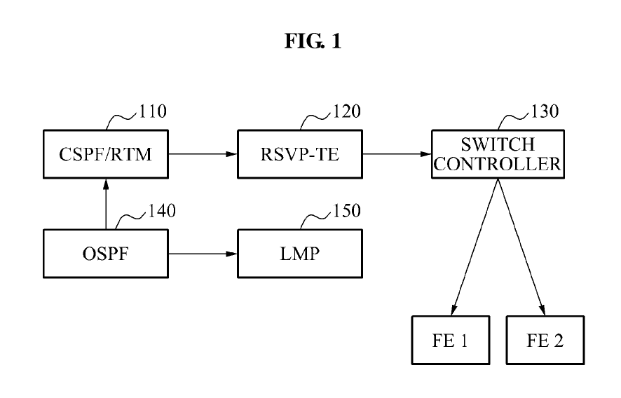

FIG. 1 is a block diagram illustrating a correlation of a generalized multiprotocol label switching (GMPLS) protocol according to an embodiment of the present invention.

Referring to FIG. 1, a resource reservation protocol-traffic engineering (RSVP-TE) 120 may correspond to a signaling protocol for setting a path. A constrained shortest path first/route table manager (CSPF/RTM) 110 may correspond to a protocol for generating a network topology and calculating a shortest path. The shortest path in a cross layer network may be calculated by applying different parameters and weights for each layer. That is, a weighted graph may be drawn by applying different TE metrics, link costs, or constraints for each layer, and an optimal multilevel path may be selected using a shortest path algorithm based on the weighted graph. Information which the CSPF/RTM 110 requires for generating a network topology may correspond to traffic engineering information of a TE link advertised by an open shortest path first (OSPF) 140. Herein, a concept of a TE link stack will be proposed so that single integrated traffic engineering information of multilevel TE links may be provided at the OSPF 140 in view of a cross layer network environment. Also, a method of managing the TE link stack in conjunction with other links at a link management protocol (LMP) 150 will be proposed.

The LMP 150 may correspond to a protocol for managing links between a first node and a second node that is adjacent to the first node. The LMP 150 may classify multiple data links into a single TE link, and may automatically match a physical port of the second node and a physical port of the first node. Also, the LMP 150 may detect a fault occurring in a data link, and may report the detected fault to the second node.

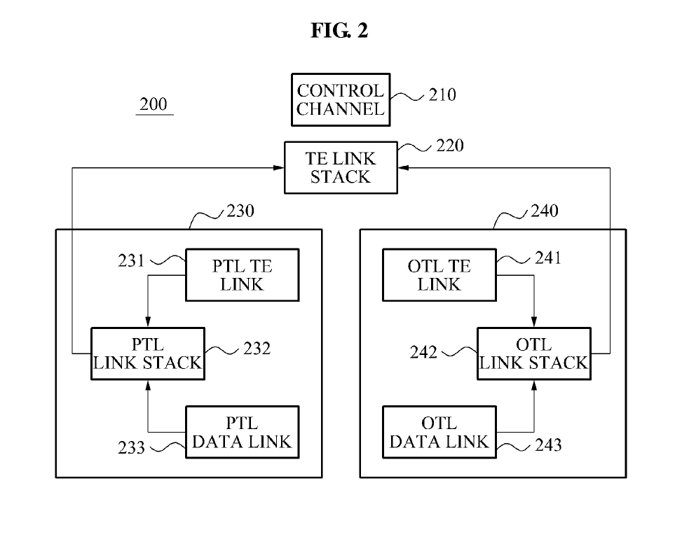

FIG. 2 is a block diagram illustrating a configuration of an apparatus for managing a multilevel link according to an embodiment of the present invention.

Referring to FIG. 2, an apparatus 200 for managing multilevel links may include a control channel 210, a TE link stack 220, packet transport layer (PTL) links 230, and optical transport layer (OTL) links 240.

The control channel 210 may be used to exchange link management protocol (LMP) information with a second node adjacent to a first node. The control channel 210 may search for the second node through a Config message, and may verify a connectivity to the second node by periodically exchanging a Hello message with the control channel of the second node.

The PTL link 230 may include PTL TE links 231, a PTL link stack 232, and PTL data links 233. In particular, the PTL link stack 232 may associate a TE link with data links of the PTL.

The OTL link 240 may include OTL TE links 241, an OTL link stack 242, and OTL data links 243. In particular, the OTL link stack 242 may associate a TE link with data links of the OTL.

The TE link stack 220 may associate the PTL link 230 with the OTL link 240, and generate a single integrated ‘TE link’ corresponding to an abstract link. The TE link may be used for easy and fast calculation of a path. A data link may refer to a link through which traffic may be transmitted, in actuality, and may correspond to a component link of the TE link. Accordingly, the TE link stack 220 may use the integrated ‘TE link’ to establish a network topology using a GMPLS control plane only, in a cross layer network environment.

A conventional link management protocol includes a data block including a TE link, a data link, and a link stack, without classification of layers. However, according to an embodiment of the present invention, in order to establish a single integrated TE link for calculating a path of a cross layer network, a function of defining a correlation of link stacks between layers and transferring the defined correlation to a routing protocol may be proposed, rather than managing link stack information for each layer independently, at a link management protocol.

The TE link stack 220 may define a correlation between the layers using a first TE link identification (ID) associated with the TE link of the OTL links 240, and a second TE link ID associated with the TE link of the PTL links 230, and may manage multilevel links for both the OTL links 240 and the PTL links 230 using the defined correlation.

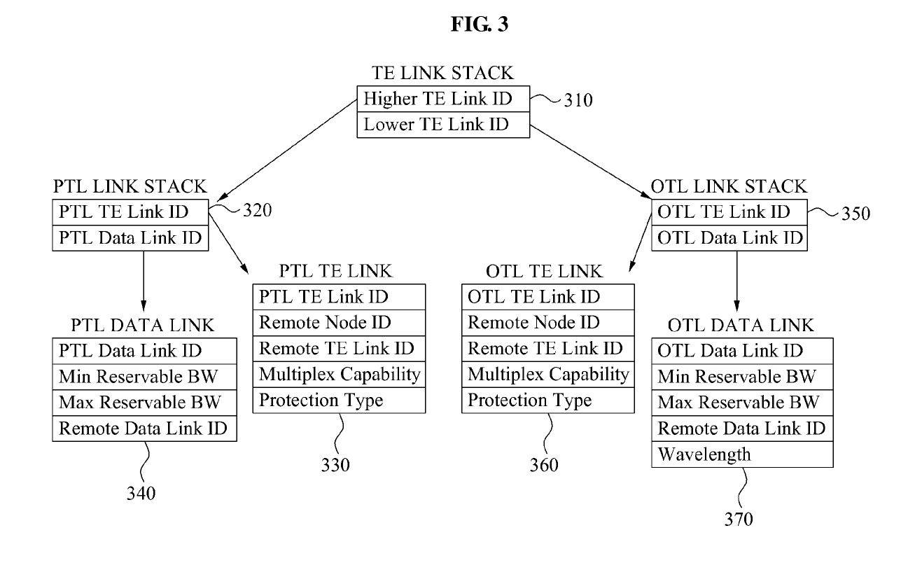

FIG. 3 is a diagram illustrating a configuration of a block to establish an integrated traffic engineering (TE) link according to an embodiment of the present invention.

Referring to FIG. 3, a TE link stack 310 may include a TE link ID of a higher layer, that is, a higher TE link ID, and a TE link ID of a lower layer, that is, a lower TE link ID, and may define a correlation between the layers. For example, the higher layer and the lower layer may correspond to one of the OTL links 240 or the PTL links 230 of FIG. 2.

As shown in FIG. 3, a PTL link stack 320 may include a PLT TE link ID and a PTL data link ID. A PTL TE link 330 and a PTL data link 340 may include link information and traffic engineering information, used for the PTL link 230, respectively.

Also, an OTL link stack 350 may include an OTL TE link ID and an OTL data link ID. An OTL TE link 360 and an OTL data link 370 may include link information and traffic engineering information, used for the OTL link 240, respectively.

The TE link stack 310 may form a correlation between the two layers.

Also, the TE link stack 220 may transmit, to a second node adjacent to a first node, a LinkSummary message including a first object having a property of a TE link and a second object having a property of the data link, and may match a link property of the second node to a link property of the first node by receiving a LinkSummaryAck message from the second node.

A state of the TE link may be determined by a finite state machine (FSM) of the TE link. When the control channel 210 of FIG. 2 is in an ‘Up’ state and a data link is allocated to a TE link, the TE link stack 220 may be in an ‘Initialization (Init)’ state and may send a LinkSummary message periodically. The LinkSummary message may include a first object having a property of a TE link, and a second object having a property of a data link. Accordingly, the TE link stack 220 may match the link property of the second node to the link property of the first node, by exchanging a LinkSummary message and a LinkSummeryAck message with the second node.

According to an embodiment of the present invention, an FSM of the TE link stack 220 may be proposed in order to match properties of integrated TE links between two layers, in conjunction with a link property correlation in a conventional link management module. The FSM of the TE link stack 220 may exchange link information of multiple layers with the second node through a modified LinkSummary message, and may reflect, in a network topology, link state information of the multiple layers that may be updated every time.

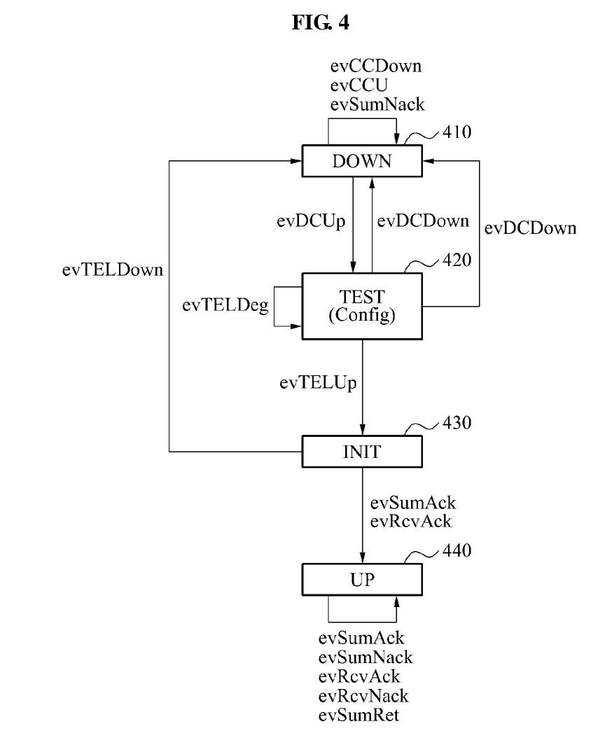

FIG. 4 is a diagram illustrating a finite state machine that defines a state of a TE link stack according to an embodiment of the present invention.

Referring to FIG. 4, a state of the TE link stack 200 of FIG. 2 may be classified into four types.

Down 410 may refer to a state in which a data link is not yet allocated to a TE link.

Test 420 may refer to a state in which a TE link is not in an ‘Up’ state although a data link is allocated to the TE link.

Init 430 may refer to a state in which the TE link stack 220 of multiple layers does not match a second node adjacent to a first node although a TE link of each layer is in an ‘Up’ state, and a state in which a LinkSummary message may be transmitted periodically.

Up 440 may refer to a state in which the TE link stack 220 may be operated normally, by receiving a LinkSummaryAck message in response to a LinkSummary message, and a state in which a LinkSummary message may be transmitted periodically.

In addition, events by which the state of the TE link stack 220 may be changed may be as follows:

(1) evDCUp indicating an allocation of at least one data link to a TE link;

(2) evSumAck indicating a positive reply to a LinkSummary message;

(3) evSumNack indicating a negative reply to a LinkSummary message;

(4) evRcvAck indicating a reception of a LinkSummaryAck message;

(5) evRcvNack indicating a reception of a LinkSummaryNack message;

(6) evSumRet indicating a re-transmission of a LinkSummary message by lapse of time;

(7) evCCUp indicating an Up of a control channel;

(8) evCCDown indicating a Down of a control channel;

(9) evDCDown indicating a removal of a data link allocated to a TE link;

(10) evTELDeg indicating a degradation of a state of a TE link for each layer;

(11) evTELDown indicating a Down of a state of a TE link for each layer; and

(12) evTELUp indicating an Up of a state of a TE link for each layer.

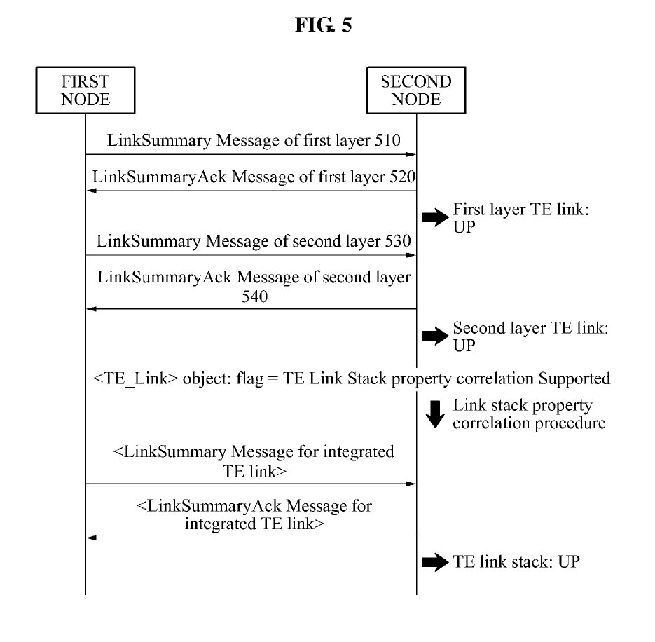

When the control channel 210 is an ‘Up’ state, and a data link is allocated to a TE link, the TE link stack 220 may be in the ‘Test’ state. In this situation, when a state of a TE link for each layer is in the ‘UP’ state, the TE link stack 220 may be changed to the ‘Init’ state. When a LinkSummary message and a LinkSummaryAck message are exchanged, as shown in FIG. 5, the TE link stack 220 may be in the ‘UP’ state.

FIG. 5 is a diagram illustrating a sequence of exchanging a LinkSummary message for a property correlation of an integrated TE link according to an embodiment of the present invention.

Referring to FIG. 5, when a first node transmits a LinkSummary message for a first layer to a second node adjacent to the first node in operation 510, and the second node transmits a LinkSummaryAck message for the first layer to the first node in operation 520, a TE link stack of the first layer may be in an ‘Up’ state. When the first node transmits a LinkSummary message for a second layer to the second node in operation 530, and the second node transmits a LinkSummaryAck message for the second layer to the first node in operation 540, a TE link stack of the second layer may be in an ‘Up’ state. Here, the first layer and the second layer may correspond to the PTL links 230 or the OTL links 240 of FIG. 2.

The TE link stack being in the ‘Up’ state may indicate that integrated TE link information of the second node and integrated TE link information of the first node may match. Accordingly, the TE link stack may transfer, to the OSPF 140 of FIG. 1, the integrated TE link information of the second node and the integrated TE link information of the first node, conjunctively, and the OSPF 140 may provide, to the CSPF/RTM 110 of FIG. 1, the integrated TE link information and TE link information of each layer, thereby a topology with respect to a cross layer network may be established to calculate an optimal multilevel path.

Herein, in order to operate an FSM of the TE link stack 220 for a cross layer network, the TE link stack 220 may form a LinkSummary message by incorporating a flag associated with the TE link in the first object. For example, when a flag of a <TE_LINK> object corresponds to ‘1,’ a fault management may be supported. When the flag of the <TE_LINK> object corresponds to ‘2,’ a link verification may be supported. When the flag of the <TE_LINK> object corresponds to ‘3,’ a property correlation of the TE link stack 220 for a cross layer network may be supported.

Configurations of a LinkSummary message, a LinkSummaryAck message, and a LinkSummaryNack message may be as follows, and a <Higher_TE_LINK> object and a <Lower_TE_LINK> object may be added to a conventional LinkSummary message.

<LinkSummary Message>::=<Common Header><MESSAGE_ID><TE_LINK><DATA_LINK>[<DATA_LINK> . . . ]<Higher_TE_LINK><Lower_TE_LINK>

<LinkSummaryAck Message>::=<Common Header><MESSAGE_ID_ACK>

<LinkSummaryNack Message>::=<Common Header><MESSAGE_ID_ACK><ERROR_CODE>[<DAYA_LINK> . . . ]<Lower_TE_LINK>

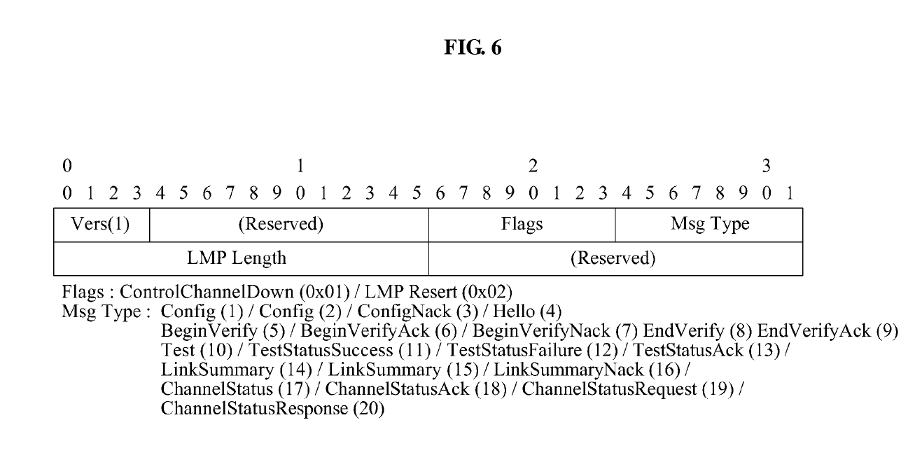

FIG. 6 is a diagram illustrating a header format of a LinkSummary message according to an embodiment of the present invention.

Referring to FIG. 6, a header of a LinkSummary message may include flags and an LMP length.

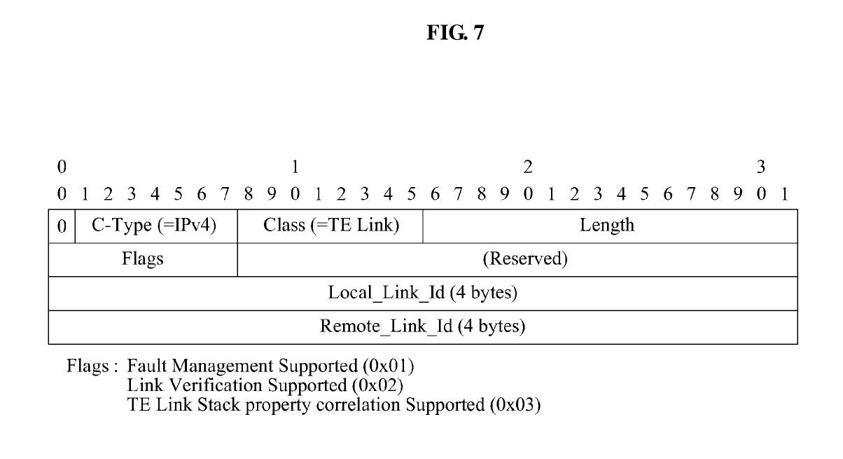

FIG. 7 is a diagram illustrating a format of a TE link object in a LinkSummary message according to an embodiment of the present invention.

Referring to FIG. 7, a LinkSummary message may be formed by incorporating a flag associated with a TE link in a first object.

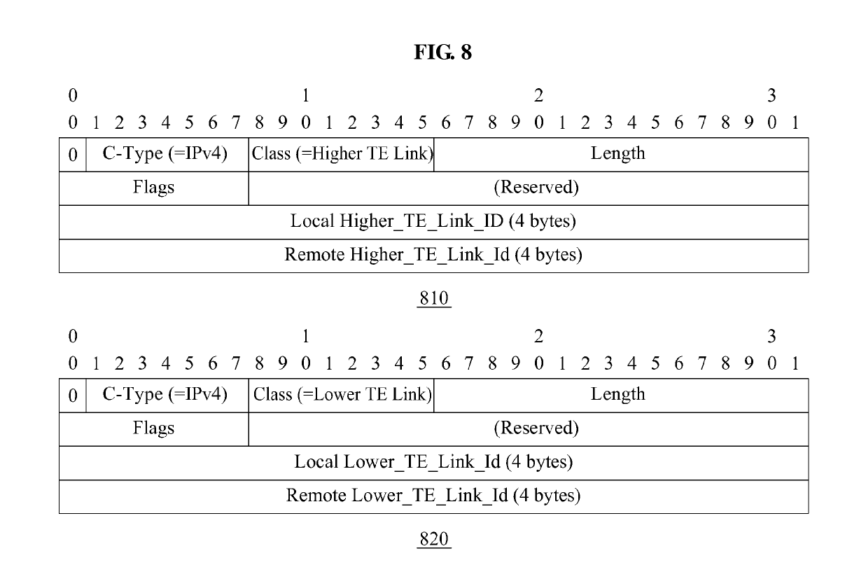

FIG. 8 is a diagram illustrating formats of TE link objects of multi-layers in a LinkSummary message according to an embodiment of the present invention.

Referring to FIG. 8, an <IPv4 Higher_TE_Link> object 810 may include a higher TE link ID of a first node, and a higher TE link ID of a second node adjacent to the first node. Also, an <IPv4 Lower_TE_Link> object 820 may include a lower TE link ID of the first node, and a lower TE link ID of the second node.

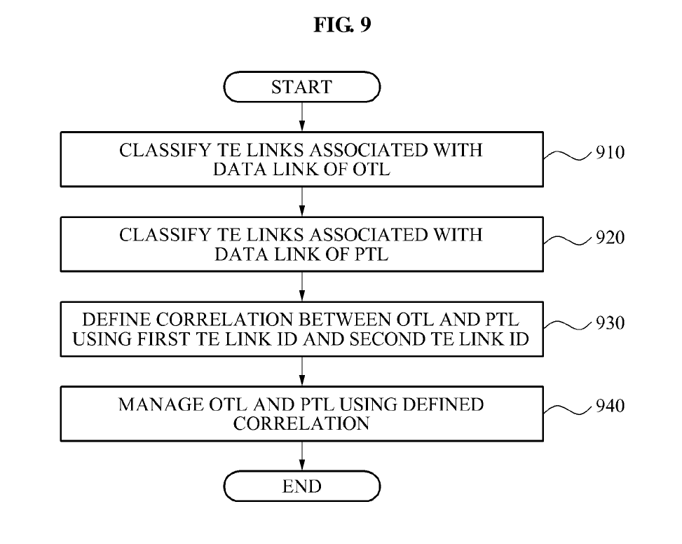

FIG. 9 is a flowchart illustrating a method of managing multilevel links according to an embodiment of the present invention.

Referring to FIG. 9, the apparatus 200 of FIG. 2 for managing a multilevel link may associate a TE link with data links of the OTL links 240 of FIG. 2.

In operation 920, the apparatus 200 may associate a TE link with data links of the PTL links 230 of FIG. 2.

In operation 930, the apparatus may define a correlation between the layers using a first TE link ID associated with the TE links of the OTL links 240, and a second TE link ID associated with the TE links of the PTL links 230.

In operation 940, the apparatus 200 may manage multilevel links for both the OTL links 240 and the PTL links 230 using the defined correlation. That is, the apparatus 200 may associate a link stack of the PTL links 230 with a link stack of the PTL links 240, and generate a single integrated ‘TE link’ corresponding to an abstract link, thereby establishing a network topology using only a GMPLS control plane in a cross layer network environment.

As another example, an LMP may additionally include a function of detecting a fault by monitoring a state of a data link in real time. However, a conventional LMP monitors a state of a data link independently for each layer. For example, in a cross layer network in which an Ethernet L2 layer and an optical layer are connected to each other, the conventional LMP monitors a state of an Ethernet link and a state of an optical link, that is, an optical fiber cable, separately. A problem in the conventional LMP lies in that it is impossible to detect a fault occurring at a physical connection point between a higher layer and a lower layer, in a cross layer network. In particular, when the lower layer corresponds to an optical layer, such as a reconfigurable optical add-drop multiplexer (ROADM) or a wavelength-division multiplexer (WDM), a fault may occur at the physical connection point between the higher layer and the lower layer unless the optical fiber cable is disconnected. Accordingly, the fault may not be detected in the lower layer since an optical signal is constantly present in an optical transmitter of a general optical transceiver although data is not transmitted.

When the data is not transmitted, in a case of using an optical transceiver of a burst mode in which an optical signal may not be transmitted, the fault detected at the physical connection point between the higher layer and the lower layer may be deemed to be a fault of the lower layer. However, a problem in that a considerable amount of time may be consumed in searching for an exact point at which a fault occurs and resolving the fault may arise, along with problems of unstable intensity of output light and ‘turn-on delay’ of the optical transceiver in the burst mode. Accordingly, in order to resolve the foregoing problems, a link state may need to be managed in an apparatus for converting a signal of a higher layer to a signal of a lower layer. Herein, a method of detecting and resolving inter-level connection point faults that may be required for managing a data link in a cross layer network will be proposed.

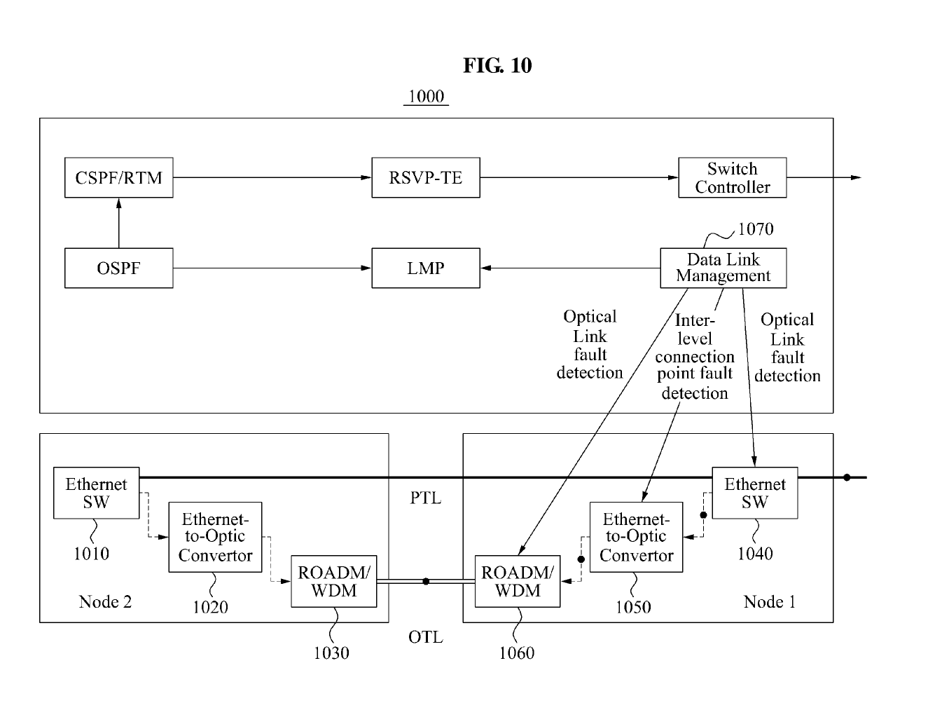

FIG. 10 is a block diagram illustrating a configuration of an apparatus for detecting faults of multilevel links according to another embodiment of the present invention.

Referring to FIG. 10, in a cross layer network including two layers, a transmission device may include an Ethernet switch 1010 or 1040, or a router to transmit packets, a WDM 1030 or 1060, a DWDM, or an ROADM to transmit optical signals, and an Ethernet-to-Optic converter 1020 or 1050, or an optical transceiver to convert packet signals to optical signals. Here, the two layers may correspond to a PTL, for example, an Ethernet layer or an IP layer, and an OTL, for example, a lambda layer or a fiber layer. A GMPLS protocol is similar to the GMPLS described with reference to FIG. 1 and thus, duplicated descriptions will be omitted for conciseness. Here, an apparatus 1000 for detecting faults multilevel links may include the Ethernet switches 1010 and 1040, the WDMs 1030 and 1060, the Ethernet-to-Optic converters 1020 and 1050, and a data link management block 1070.

As a sub-block of an LMP in the GMPLS, the data link management block 1070 may report a fault to the LMP immediately when the fault is detected by monitoring a link state of each layer in real time. The data link management block 1070 may detect a link state of the Ethernet-to-Optic converter 1020 or 1050 corresponding to a connection point between the PTL and the OTL. The data link management block 1070 may detect a fault of the connection point using the link state, and may report, to a second node adjacent to a first node, a change in a data link state at the detected connection point.

A state management point of the Ethernet-to-Optic Converter 1020 or 1050 may correspond to an ‘Ethernet link connection point’ which is connected to the Ethernet switch 1010 or 1040, and an ‘optical link connection point’ which is connected to the WDM 1030 or 1060. The data link management block 1070 may report a link fault to a second node adjacent to a first node using a ChannelStatus message. When a fault occurs at the Ethernet-to-Optic Converter 1020 or 1050 between the two layers, the data link management block 1070 may detect the inter-level connection point fault, and may convert a state of a data link for a lower layer allocated to the connection point between the layers to ‘fail.’ Also, the data link management block 1070 may report, to the second node, a data link fault of the lower layer using the ChannelStatus message.

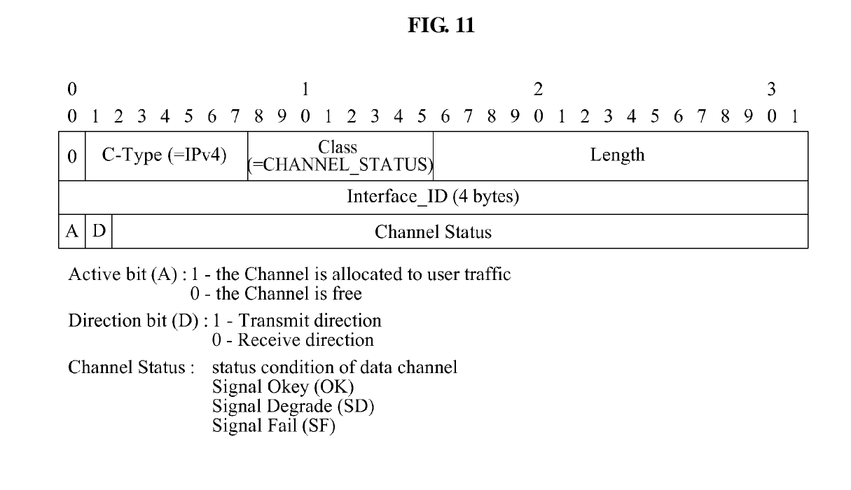

FIG. 11 is a diagram illustrating a format of a ChannelStatus message according to an embodiment of the present invention.

Referring to FIG. 11, a ChannelStatus message may include a local link ID, a message ID, a channel state, and the like.

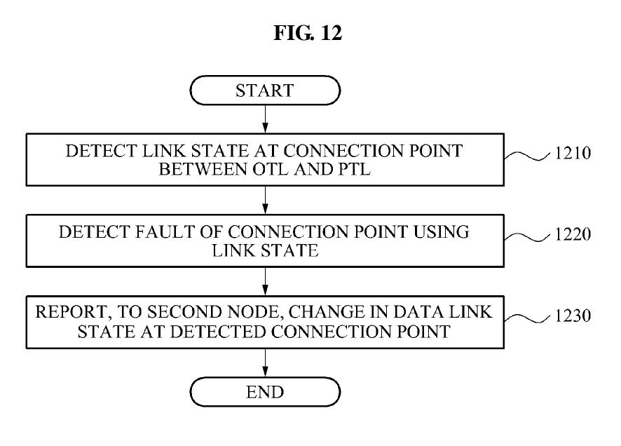

FIG. 12 is a flowchart illustrating a method of detecting faults of multilevel links according to another embodiment of the present invention.

Referring to FIG. 12, the apparatus 1000 of FIG. 10 for detecting faults multilevel links may detect a link state at a connection point between an OTL and a PTL, in operation 1210.

In operation 1220, the apparatus 1000 may detect a fault of the connection point using the link state.

In operation 1230, the apparatus 1000 may report, to a second node adjacent to a first node, a change in a data link state at the detected connection point.

When a fault occurs at the connection point, the apparatus 1000 may convert a state of a data link for a lower layer allocated at the connection point between the layers to ‘fail,’ and may report, to the second node, a data link fault of the lower layer using a ChannelStatus message.

The methods according to the embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for managing a multilevel link, the apparatus comprising:
an optical transport layer (OTL) link stack to associate a traffic engineering (TE) link with data links of an OTL;
a packet transport layer (PTL) link stack to associate a TE link with data links of a PTL; and
a TE link stack to define a correlation between the layers using a first TE link identification (ID) associated with the TE links of the OTL, and a second TE link ID associated with the TE links of the PTL, and to manage multilevel links for both the OTL and the PTL using the defined correlation.

2. The apparatus of claim 1, wherein the TE link stack transmits, to a second node adjacent to a first node, a LinkSummary message comprising a first object having a property of a TE link, and a second object having a property of the data link, and matches a link property of the second node to a link property of the first node by receiving a LinkSummaryAck message from the second node.

3. The apparatus of claim 2, further comprising:
a control channel to exchange link manger protocol (LMP) information with the second node, to search for the second node through a Config message, and to verify a connectivity to the second node by periodically exchanging a Hello message with the second node.

4. The apparatus of claim 2, wherein the TE link stack comprising:
a finite state machine (FSM) to exchange link state information of multiple layers with the second node through the LinkSummary message, and to reflect the link state information of the multiple layers in a network topology.

5. The apparatus of claim 2, wherein the TE link stack forms the LinkSummary message by incorporating a flag of the TE link in the first object.

6. An apparatus for detecting faults of multilevel links, the apparatus comprising:
a converter to monitor a link state at a connection point between an optical transport layer (OTL) and a packet transport layer (PTL); and
a data link management block to detect a fault of the connection point using the link state, and to report, to a second node adjacent to a first node, a change in a data link state at the detected connection point.

7. The apparatus of claim 6, wherein the data link management block converts a state of a data link for a lower layer allocated at the connection point between the layers to ‘fail’ when a fault occurs at the connection point, and reports, to the second node, a link fault of the lower layer using a ChannelStatus message.

8. A method of managing a multilevel link, the method comprising:
associating a traffic engineering (TE) link with data links of an optical transport layer (OTL);
associating a TE link with data links of a packet transport layer (PTL);
defining a correlation between the layers using a first TE link identification (ID) associated with the TE links of the OTL, and a second TE link ID associated with the TE links of the PTL; and
managing multilevel links for both the OTL and the PTL using the defined correlation.

9. The method of claim 8, wherein the managing comprises:
transmitting, to a second node adjacent to a first node, a LinkSummary message comprising a first object having a property of a TE link, and a second object having a property of the data link; and
matching a link property of the second node to a link property of the first node by receiving a LinkSummaryAck message from the second node.

10. The method of claim 9, further comprising:
exchanging link manger protocol (LMP) information with the second node;
searching for the second node through a Config message; and
verifying a connectivity to the second node by periodically exchanging a Hello message with the second node.

11. The method of claim 9, further comprising:
exchanging link state information of multiple layers with the second node through the LinkSummary message using a finite state machine (FSM); and
reflecting the link state information of the multiple layers in a network topology.

12. The method of claim 9, further comprising:
forming the LinkSummary message by incorporating a flag of the TE link in the first object.

13. A method of detecting faults of multilevel links, the method comprising:
monitoring a link state at a connection point between an optical transport layer (OTL) and a packet transport layer (PTL);
detecting a fault of the connection point using the link state; and
reporting, to a second node adjacent to a first node, a change in a data link state at the detected connection point.

14. The method of claim 13, wherein the reporting comprises:
converting a state of a data link for a lower layer allocated at the connection point between the layers to ‘fail’ when a fault occurs at the connection point; and
reporting, to the second node, a data link fault of the lower layer using a ChannelStatus message.
